(19) United States
(12) Patent Application Publication
(10) Pub. No.: US 2022/0082879 A1
(43) Pub. Date: Mar. 17, 2022

(54) DISPLAY PANEL AND DISPLAY DEVICE

(71) Applicant: BOE TECHNOLOGY GROUP CO., LTD., Beijing (CN)

(72) Inventors: Yingtao Wang, Beijing (CN); Xinxing Wang, Beijing (CN)

(73) Assignee: BOE TECHNOLOGY GROUP CO., LTD.

(21) Appl. No.: 17/226,126

(22) Filed: Apr. 9, 2021

(30) Foreign Application Priority Data
Sep. 17, 2020 (CN) 202010982468.0

(51) Int. Cl. G02F 1/137; G02F 1/1335; G02F 1/1343; G02F 1/13357

(52) U.S. Cl. CPC G02F 1/13725; G02F 1/133528; G02F 1/13362; G02F 1/134309; G02F 1/133514

(57) ABSTRACT

A display panel includes a first guest-host liquid crystal cell with first guest-host liquid crystal molecules, and a second guest-host liquid crystal cell with second guest-host liquid crystal molecules. An alignment direction of the first guest-host liquid crystal molecules is perpendicular to an alignment direction of the second guest-host liquid crystal molecules.

This application claims priority to Chinese Patent Application No. 202010982468.0, filed on Sep. 17, 2020 and entitled “DISPLAY PANEL AND DISPLAY DEVICE,” the disclosure of which is incorporated herein by reference in its entirety.

### TECHNICAL FIELD

The present disclosure relates to the field of display technologies, and in particular, relates to a display panel and a display device.

### BACKGROUND

At present, liquid crystal display panels may be categorized into transmissive liquid crystal display panels, reflective liquid crystal display panels, and transflective display panels according to the type and arrangement of the light source used in the liquid crystal display panels. The reflective liquid crystal display panel mainly realizes image display by reflecting light incident to the inside thereof.

In the related art, a reflective liquid crystal display panel generally includes a polarizer, two substrates arranged opposite to each other, and twisted nematic (TN) liquid crystal molecules filled between the two substrates. When the TN-type liquid crystal molecules are deflected, light pass through and is reflected.

### SUMMARY

Embodiments of the present disclosure provide a display panel and a display device.

In one aspect of the embodiments of the present disclosure, a display panel is provided. The display panel includes a first guest-host liquid crystal cell and a second guest-host liquid crystal cell that are laminated in sequence; wherein

the first guest-host liquid crystal cell includes a first substrate, a reflective electrode, first guest-host liquid crystal molecules, a first drive electrode, and a second substrate that are laminated in sequence; and

the second guest-host liquid crystal cell includes a third substrate, a second drive electrode, second guest-host liquid crystal molecules, a third drive electrode, and a fourth substrate that are laminated in sequence;

wherein an alignment direction of the first guest-host liquid crystal molecules is perpendicular to an alignment direction of the second guest-host liquid crystal molecules.

In some embodiments, a pitch between the first drive electrode and the second drive electrode is less than a pitch threshold.

In some embodiments, a side of the reflective electrode distal from the first substrate is uneven.

In some embodiments, the display panel further includes a front light source disposed on a side of the first drive electrode distal from the first guest-host liquid crystal molecules, wherein the front light source is configured to emit target light.

In some embodiments, the front light source is disposed between the third drive electrode and the fourth substrate.

In some embodiments, the front light source is disposed on a side of the fourth substrate distal from the third drive electrode.

In some embodiments, in a powered state, the alignment direction of the first guest-host liquid crystal molecules is perpendicular to the alignment direction of the second guest-host liquid crystal molecules;

in an unpowered state, the target light in a first polarization direction sequentially passes through the second guest-host liquid crystal cell and the first guest-host liquid crystal cell, is reflected by the reflective electrode, and then sequentially passes through the first guest-host liquid crystal cell and the second guest-host liquid crystal cell; and

in the powered state, the target light in a second polarization direction passes through the second guest-host liquid crystal cell to the first guest-host liquid crystal cell, and is absorbed by the first guest-host liquid crystal molecules.

In some embodiments, in an unpowered state, the alignment direction of the first guest-host liquid crystal molecules is perpendicular to the alignment direction of the second guest-host liquid crystal molecules;

in the unpowered state, the target light in a first polarization direction passes through the second guest-host liquid crystal cell to the first guest-host liquid crystal cell, and is absorbed by the first guest-host liquid crystal molecules; and

in a powered state, the target light in a second polarization direction sequentially passes through the second guest-host liquid crystal cell and the first guest-host liquid crystal cell, and is reflected by the reflective electrode, and then sequentially passes through the first guest-host liquid crystal cell and the second guest-host liquid crystal cell.

In some embodiments, the front light source is disposed on a side of the third substrate distal from the second drive electrode.

In some embodiments, in a powered state, the alignment direction of the first guest-host liquid crystal molecules is perpendicular to the alignment direction of the second guest-host liquid crystal molecules;

in an unpowered state, the target light in a first polarization direction passes through the first guest-host liquid crystal cell, and is reflected by the reflective electrode, and then sequentially passes through the first guest-host liquid crystal cell and the second guest-host liquid crystal cell; and

in the powered state, the target light in a second polarization direction passes through the first guest-host liquid crystal cell, is reflected by the reflective electrode, and then passes through the first guest-host liquid crystal cell to the second guest-host liquid crystal cell and is absorbed by the second guest-host liquid crystal molecules.

In some embodiments, in an unpowered state, the alignment direction of the first guest-host liquid crystal molecules is perpendicular to the alignment direction of the second guest-host liquid crystal molecules;

in the unpowered state, the target light in a first polarization direction passes through the first guest-host liquid crystal cell, is reflected by the reflective electrode, and then passes through the first guest-host liquid crystal cell to the second guest-host liquid crystal cell, and is absorbed by the second guest-host liquid crystal molecules; and

in the powered state, the target light in a second polarization direction passes through the first guest-host liquid crystal cell, is reflected by the reflective electrode, and then sequentially passes through the first guest-host liquid crystal cell and the second guest-host liquid crystal cell.

In some embodiments, the front light source includes a plurality of micro light-emitting diodes evenly arranged.

In some embodiments, the front light source further includes an insulating layer configured to package the plurality of micro light-emitting diodes.

In some embodiments, at least one of the first substrate, the second substrate, the third substrate, and the fourth substrate is a flexible substrate.

In some embodiments, the second substrate is shared with the third substrate.

In some embodiments, the first drive electrode, the second drive electrode, the third drive electrode, and the fourth drive electrode are all transparent thin-film electrodes.

In some embodiments, the reflective electrode satisfies one of the following conditions: a metal electrode and a reflective layer are laminated in a direction distal from the first substrate, and the reflective electrode is made of a conductive material with a reflectivity greater than a reflectivity threshold.

In some embodiments, the display panel further includes a color filter disposed on a side of the fourth substrate distal from the fourth drive electrode.

In another aspect of the embodiments of the present disclosure, a display device is provided. The display device includes a drive circuit and a display panel. The drive circuit is connected to the display panel. The drive circuit is configured to drive the display panel to operate.

The display panel includes a first guest-host liquid crystal cell and a second guest-host liquid crystal cell that are laminated in sequence, wherein

the first guest-host liquid crystal cell includes a first substrate, a reflective electrode, first guest-host liquid crystal molecules, a first drive electrode, and a second substrate that are laminated in sequence;

the second guest-host liquid crystal cell includes a third substrate, a second drive electrode, second guest-host liquid crystal molecules, a third drive electrode, and a fourth substrate that are laminated in sequence; and

wherein an alignment direction of the first guest-host liquid crystal molecules is perpendicular to an alignment direction of the second guest-host liquid crystal molecules.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic structural diagram of a display panel according to an embodiment of the present disclosure;

FIG. 2 is a schematic structural diagram of another display panel according to an embodiment of the present disclosure;

FIG. 3 is a schematic structural diagram of another display panel according to an embodiment of the present disclosure;

FIG. 4 is a schematic structural diagram of still another display panel according to an embodiment of the present disclosure;

FIG. 5 is a schematic structural diagram of still another display panel according to an embodiment of the present disclosure;

FIG. 6 is a schematic structural diagram of still another display panel according to an embodiment of the present disclosure;

FIG. 7 is a schematic structural diagram of still another display panel according to an embodiment of the present disclosure;

FIG. 8 is a schematic structural diagram of still another display panel according to an embodiment of the present disclosure;

FIG. 9 is a schematic structural diagram of still another display panel according to an embodiment of the present disclosure;

FIG. 10 is a schematic structural diagram of still another display panel according to an embodiment of the present disclosure;

FIG. 11 is a schematic structural diagram of still another display panel according to an embodiment of the present disclosure; and

FIG. 12 is a schematic structural diagram of a display device according to an embodiment of the present disclosure.

### DETAILED DESCRIPTION

For clearer descriptions of the objectives, technical solutions, and advantages of the present disclosure, embodiments of the present disclosure are described in detail hereinafter with reference to the accompanying drawings.

Currently, in addition to TN-type reflective liquid crystal display (LCD) panels, there are other types of reflective LCD panels, such as electrically controlled birefringence (ECB) LCD panels. However, whether it is a TN-type LCD panel or an ECB-type LCD panel, an additional polarizer or compensation film is required, and the reflectivity can only reach about 35% under ideal conditions, which makes the display effect poor. If the current LN-type LCD panel or ECB-type LCD panel is applied to e-book products with high reflectivity requirements, the user experience is affected.

Embodiments of the present disclosure provide a double-layer guest-host mode reflective LCD panel, which not only does not require additional polarizers and compensation films, but also has better reflectivity. To be specific, the reflective LCD panel according to the embodiment of the present disclosure has a simple structure and a better display effect.

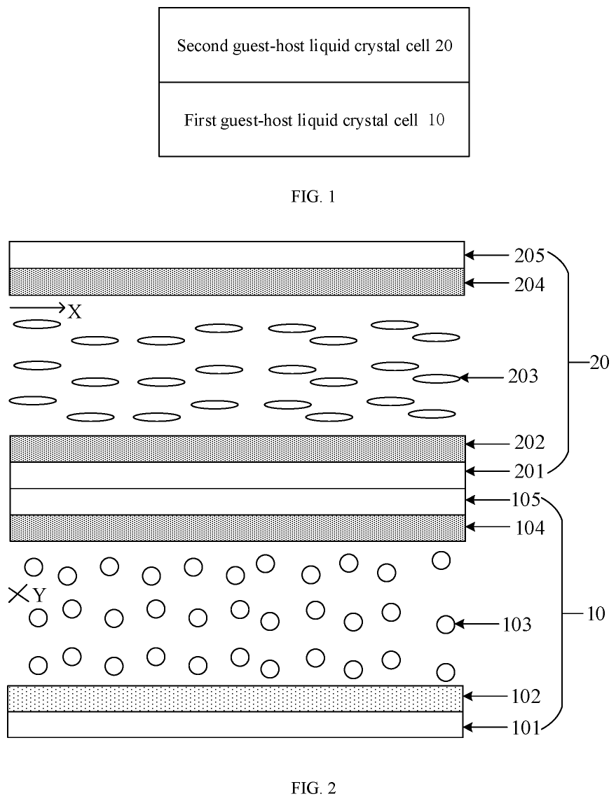

FIG. 1 is a schematic structural diagram of a display panel according to an embodiment of the present disclosure. As shown in FIG. 1, the display panel may include a first guest-host liquid crystal cell 10 and a second guest-host liquid crystal cell 20 that are laminated in sequence.

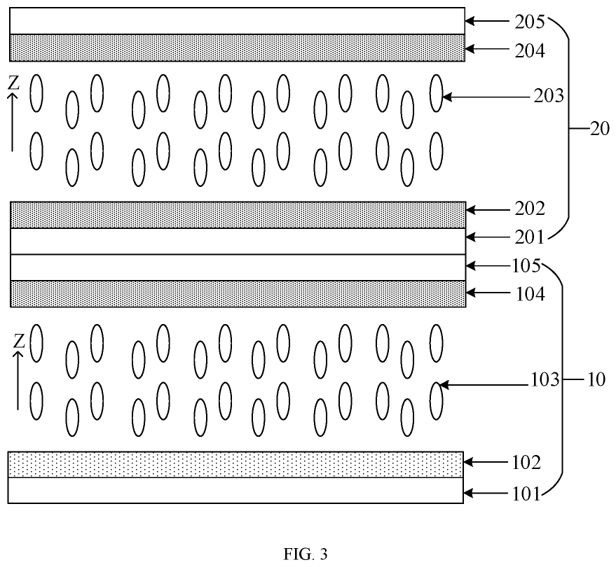

FIG. 2 is a schematic structural diagram of another display panel according to an embodiment of the present disclosure. As seen in conjunction with FIG. 1 and FIG. 2, the first guest-host liquid crystal cell 10 may include a first substrate 101, a reflective electrode 102, first guest-host liquid crystal molecules 103, a first drive electrode 104, and a second substrate 105 that are laminated in sequence. The second guest-host liquid crystal cell 20 may include a third substrate 201, a second drive electrode 202, second guest-host liquid crystal molecules 203, a third drive electrode 204, and a fourth substrate 205 laminated in sequence. To be specific, as shown in FIG. 2, the third substrate 201 may be arranged in contact with the second substrate 105. Moreover, based on the placement position of the reflective electrode 102, it may be known that an upper surface of the fourth substrate 205 may face a viewer and be used for displaying images. The guest-host liquid crystal molecules refer to liquid crystal molecules filled with dichroic dye molecules.

It should be noted that, as shown in FIG. 2, the display panel according to the embodiment of the present disclosure may have a plurality of first guest-host liquid crystal molecules 103 interspersed between the reflective electrode 102 and the first drive electrode 104, and a plurality of second guest-host liquid crystal molecules 203 interspersed between the second drive electrode 202 and the third drive electrode 204.

In some embodiments, the reflective electrode 102 may be a reflective layer provided on a side of an electrode facing a display area. To be specific, the reflective electrode 102 may include an electrode and a reflective layer laminated in sequence. Alternatively, the reflective electrode 102 may also be an electrode made of a conductive material with a higher reflectivity, which is not limited in the embodiment of the present disclosure.

Still referring to FIG. 2, in the embodiment of the present disclosure, an alignment direction of the first guest-host liquid crystal molecules 103 may be perpendicular or orthogonal to an alignment direction of the second guest-host liquid crystal molecules 203. The alignment direction of the liquid crystal molecules may be interpreted as an extension direction of a long axis of the liquid crystal molecules. In this way, the display panel according to the embodiment of the present disclosure may also be referred to as an orthogonal double cell structure.

In some embodiments, as shown in FIG. 2, the first guest-host liquid crystal molecules 103 may be arranged horizontally with the long axis extending in the Y direction. To be specific, the alignment direction is Y. The second guest-host liquid crystal molecules 203 may be arranged horizontally with the long axis extending along the X direction. To be specific, the alignment direction is X. The X direction and the Y direction are perpendicular to each other. In this way, if the alignment direction of the guest-host liquid crystal molecules is set by a rubbing process, in the embodiment of the present disclosure, the rubbing directions should be perpendicular to each other. The rubbing process may be interpreted as rubbing and aligning a liquid crystal alignment layer arranged in the guest-host liquid crystal cell.

In some embodiments, a first alignment layer may be provided on a side of the first substrate 101 facing the first guest-host liquid crystal molecules 103. A second alignment layer may be provided on a side of the second substrate 105 facing the first guest-host liquid crystal molecules 103. The rubbing directions of the first alignment layer and the second alignment layer may both be parallel to the Y direction. Similarly, a third alignment layer may be provided on a side of the third substrate 201 facing the second guest-host liquid crystal molecules 203. A fourth alignment layer may be provided on a side of the fourth substrate 205 facing the second guest-host liquid crystal molecules 203. The rubbing directions of the third alignment layer and the fourth alignment layer may both be parallel to the X direction.

It should be noted that the Y direction may be interpreted as a direction perpendicular to the paper, and the symbol “x” in the drawings indicates that the long axis of each of the first guest-host liquid crystal molecules 103 extends in a direction perpendicular to the paper.

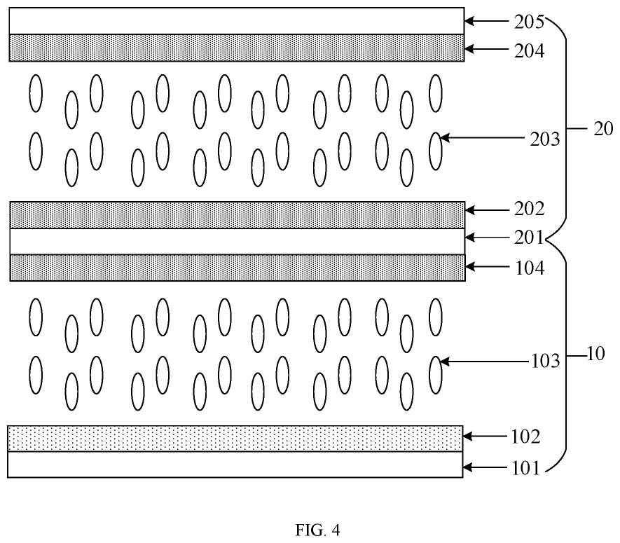

It should also be noted that, for normal display by the display panel, the alignment direction of the first guest-host liquid crystal molecules 103 being perpendicular to the alignment direction of the second guest-host liquid crystal molecules 203 may be practiced as follows: in a powered state, the alignment direction of the first guest-host liquid crystal molecules 103 is perpendicular to the alignment direction of the second guest-host liquid crystal molecules 203. To be specific, the display panel shown in FIG. 2 may be a display panel in a powered state. Accordingly, in the powered state, the alignment direction of the first guest-host liquid crystal molecules 103 may be parallel to the alignment direction of the second guest-host liquid crystal molecules 203. For example, in another display panel as shown in FIG. 3, in an unpowered state, the first guest-host liquid crystal molecules 103 and the second guest-host liquid crystal molecules 203 may be arranged vertically with the long axes extending along the Z direction. In this way, the powered state may be controlled such that the display panel can effectively absorb light and effectively reflect light to achieve a normally white mode.

In some embodiments, the alignment direction of the first guest-host liquid crystal molecules 103 being perpendicular to the alignment direction of the second guest-host liquid crystal molecules 203 may be practiced as follows: in an unpowered state, the alignment direction of the first guest-host liquid crystal molecules 103 is perpendicular to the alignment direction of the second guest-host liquid crystal molecules 203. To be specific, the display panel shown in FIG. 2 may be a display panel in an unpowered state. Accordingly, in the powered state, the alignment direction of the first guest-host liquid crystal molecules 103 may be parallel to the alignment direction of the second guest-host liquid crystal molecules 203. To be specific, the display panel shown in FIG. 3 may be a display panel in a powered state. In this way, the powered state may be controlled such that the display panel can effectively absorb light and effectively reflect light to achieve a normally black mode.

In summary, the embodiments of the present disclosure provide a display panel including a first guest-host liquid crystal cell having first guest-host liquid crystal molecules and a second guest-host liquid crystal cell having second guest-host liquid crystal molecules. Since an alignment direction of the first guest-host liquid crystal molecules is perpendicular to an alignment direction of the second guest-host liquid crystal molecules, light may be effectively reflected or absorbed by the first guest-host liquid crystal cell and the second guest-host liquid crystal cell. To be specific, the display panel according to the embodiment of the present disclosure can not only display images normally, but also has a higher light reflectivity and a better display effect.

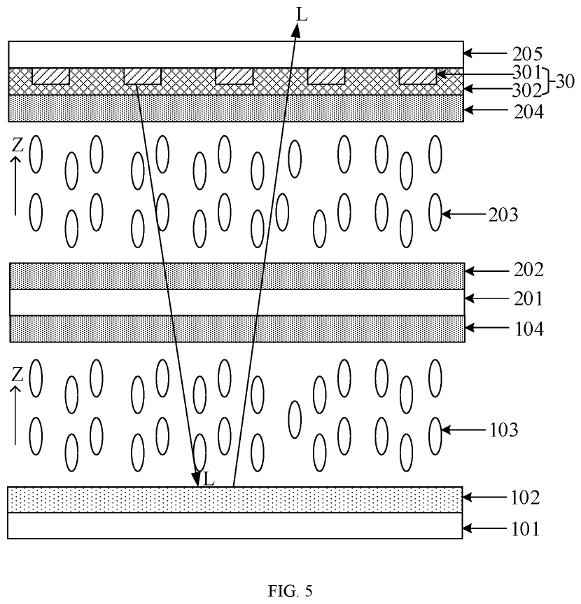

In some embodiments, for reduction of the overall thickness of the display panel, the second substrate 105 and the third substrate 201 that are in contact with each other may be shared. To be specific, in combination with the display panels shown in FIGS. 3 and 4, the second substrate 105 and the third substrate 201 according to the embodiment of the present disclosure may be the same substrate (labeled 201 in FIG. 4).

In some embodiments, light incident on a reflective LCD panel may be ambient light (i.e., natural light). Thus, for normal display by the display panel, the display panel needs to be placed in an outdoor environment with sufficient ambient light. In addition, with reference to the above drawings, the upper surface of the fourth substrate 205 may be used as an incident surface of ambient light.

In some embodiments, light incident on the reflective LCD panel may be light emitted by a light source. For example, as shown in the display panel shown in FIG. 5, the display panel according to the embodiment of the present disclosure may further include a front light source 30 disposed on a side of the first drive electrode 104 distal from the first guest-host liquid crystal molecules 103. The front light source 30 may be intended to emit target light. In this way, regardless the display panel is placed in an outdoor environment with sufficient ambient light or an environment with insufficient ambient light (such as a dark indoor environment), the display panel can display normally.

In some embodiments, when the display panel includes the front light source 30, the front light source 30 may be disposed above the reflective electrode 102. To be specific, the reflective electrode 102 may face the display side.

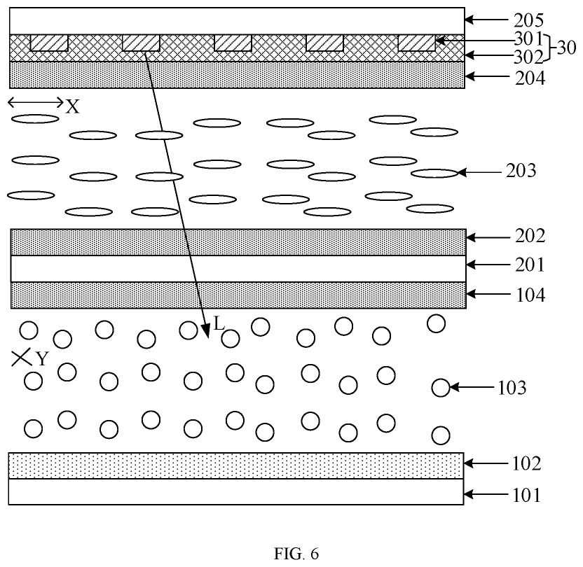

In some embodiments, referring to the display panels shown in FIGS. 5 and 6, the front light source 30 may be disposed between the third drive electrode 204 and the fourth substrate 205.

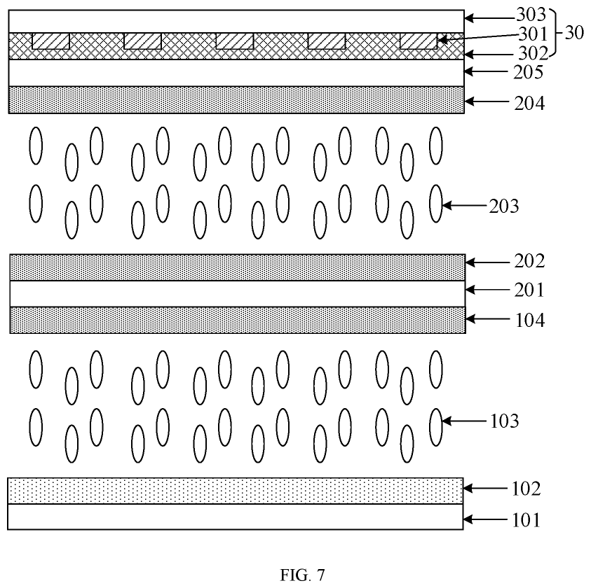

In some embodiments, referring to the display panel shown in FIG. 7, the front light source 30 may be disposed on a side of the fourth substrate 205 distal from the third drive electrode 204. To be specific, the front light source 30 may be disposed above the second guest-host liquid crystal cell 20. In other words, the front light source 30 may be disposed outside the two laminated guest-host liquid crystal cells.

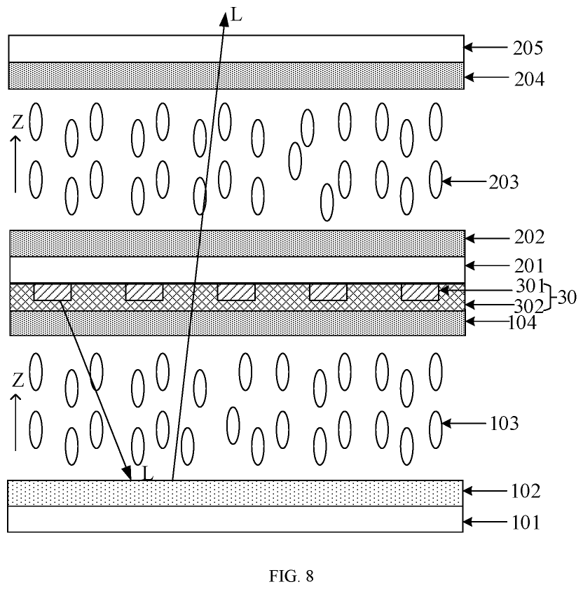

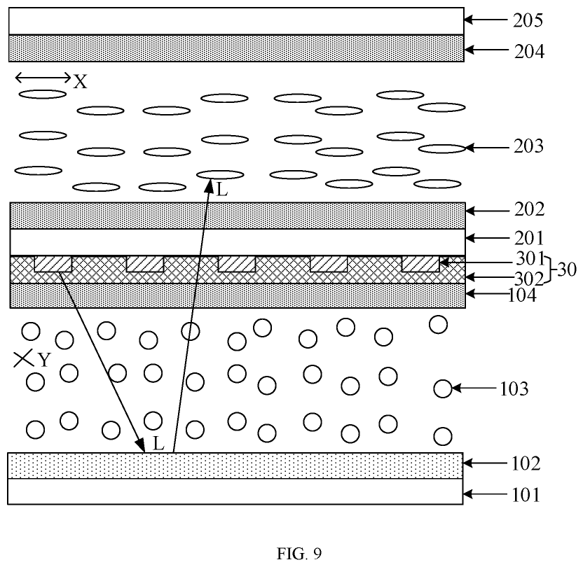

In some embodiments, referring to the display panels shown in FIGS. 8 and 9, the front light source 30 may be disposed on a side of the third substrate 201 distal from the second drive electrode 202. If the second substrate 105 and the third substrate 201 are the same substrate, for the display panels shown in FIGS. 8 and 9, the front light source 30 is actually disposed between the third substrate 201 and the first drive electrode 104.

The display principle of the display panel shown in any one of FIGS. 5 to 7 is described by taking the normally white mode as an example. If the display panel operates in the normally white mode, the alignment direction of the first guest-host liquid crystal molecules 103 being perpendicular to the alignment direction of the second guest-host liquid crystal molecules 203 may be interpreted as being perpendicular in a powered state.

First, in conjunction with the display panel shown in FIG. 5, in an initial state (i.e., an unpowered state), the first guest-host liquid crystal molecules 103 and the second guest-host liquid crystal molecules 203 may be arranged vertically. To be specific, the alignment direction of the first guest-host liquid crystal molecules 103 may be parallel to the alignment direction of the second guest-host liquid crystal molecules 203. For example, the alignment directions are both the Z direction. In this way, target light L in a first polarization direction (which may include the X direction and/or the Y direction) emitted by the front light source 30 may sequentially pass through the second guest-host liquid crystal cell 20 and the first guest-host liquid crystal cell 10, and is reflected by the reflective electrode 102, and then sequentially pass through the first guest-host liquid crystal cell 10 and the second guest-host liquid crystal cell 20, thereby realizing reflective display. To be specific, neither the first guest-host liquid crystal molecules 103 nor the second guest-host liquid crystal molecules 203 are capable of blocking the target light. The incident light is the same as the ambient light. In this initial state, the ambient light may be incident into the two guest-host liquid crystal cells, reflected by the reflective electrode 102, and then reflected out of the two guest-host liquid crystal cells in the original incident state. In the following embodiments, the principle of ambient light incidence is not repeated herein.

Secondly, in conjunction with the display panel shown in FIG. 6, when a voltage is applied, that is, in a powered state, the alignment direction of the first guest-host liquid crystal molecules 103 may be perpendicular to the alignment direction of the second guest-host liquid crystal molecules 203. In this way, when the target light L is incident into the second guest-host liquid crystal cell 20, light whose polarization direction is the same as the alignment direction of the second guest-host liquid crystal molecules 203 cannot pass through the second guest-host liquid crystal cell 20 to reach the first guest-host liquid crystal cell 10. Light whose polarization direction is different from the alignment direction of the second guest-host liquid crystal molecules 203 can pass through the second guest-host liquid crystal cell 20 to reach the first guest-host liquid crystal cell 10. In other words, after the target light L is incident into the second guest-host liquid crystal cell 20, the polarization direction of the target light L changes due to the alignment direction of the second guest-host liquid crystal molecules 203. Moreover, since the alignment direction of the first guest-host liquid crystal molecules 103 is perpendicular to the alignment direction of the second guest-host liquid crystal molecules 203, when light reaches the first guest-host liquid crystal cell 10, the light is absorbed (i.e., blocked) by the first guest-host liquid crystal molecules 103, and cannot reach the reflective electrode 102, such that reflection cannot be achieved, and the display panel is in a dark state. To be specific, in the powered state, the target light in a second polarization direction can pass through the second guest-host liquid crystal cell 20 to the first guest-host liquid crystal cell 10 and be absorbed by the first guest-host liquid crystal molecules 103.

In some embodiments, assuming that the alignment direction of the first guest-host liquid crystal molecules 103 changes from the Z direction shown in FIG. 5 to the Y direction shown in FIG. 6, and the alignment direction of the second guest-host liquid crystal molecules 203 changes from the Z direction shown in FIG. 5 to the X direction shown in FIG. 6, then the second polarization direction is the Y direction. In other words, among the target light L, only light whose polarization direction is the Y direction can pass through the second guest-host liquid crystal cell 20 to the first guest-host liquid crystal cell 10 and be absorbed by the first guest-host liquid crystal molecules 103 whose alignment direction is the Y direction. The same applies to ambient light.

The display principle of the display panels shown in FIG. 5 and FIG. 6 is described by taking the normally black mode as an example. If the display panel operates in the normally black mode, the alignment direction of the first guest-host liquid crystal molecules 103 being perpendicular to the alignment direction of the second guest-host liquid crystal molecules 203 may be interpreted as being perpendicular in an unpowered state.

First, in conjunction with the display panel shown in FIG. 6, in an initial state, the first guest-host liquid crystal molecules 103 may be perpendicular to the second guest-host liquid crystal molecules 203. In this way, when the target light L is incident into the second guest-host liquid crystal cell 20, the target light L whose polarization direction is the same as the alignment direction of the second guest-host liquid crystal molecules 203 cannot pass through the second guest-host liquid crystal cell 20 to reach the first guest-host liquid crystal cell 10. Only light whose polarization direction is different from the alignment direction of the second guest-host liquid crystal molecules 203 can pass through the second guest-host liquid crystal cell 20 to reach the first guest-host liquid crystal cell 10. Moreover, since the alignment direction of the first guest-host liquid crystal molecules 103 is perpendicular to the alignment direction of the second guest-host liquid crystal molecules 203, when light reaches the first guest-host liquid crystal cell 10, the light is also absorbed by the first guest-host liquid crystal molecules 103 and cannot reach the reflective electrode 102, such that reflection cannot be achieved, and the display panel is in a dark state. To be specific, in the initial state, the target light L in the first polarization direction passes through the second guest-host liquid crystal cell 20 to the first guest-host liquid crystal cell 10 and is absorbed by the first guest-host liquid crystal molecules 103.

In some embodiments, assuming that the alignment direction of the second guest-host liquid crystal molecules 203 is the X direction shown in FIG. 6, and the alignment direction of the first guest-host liquid crystal molecules 103 is the Y direction shown in FIG. 6, then the first polarization direction is the Y direction. In other words, among the target light L, only light whose polarization direction is the Y direction can pass through the second guest-host liquid crystal cell 20 to the first guest-host liquid crystal cell 10, and be absorbed by the first guest-host liquid crystal molecules 103 whose alignment direction is the Y direction. The same applies to ambient light.

Second, in conjunction with the display panel shown in FIG. 5, in a powered state, the first guest-host liquid crystal molecules 103 and the second guest-host liquid crystal molecules 203 may be arranged vertically. To be specific, the alignment direction of the first guest-host liquid crystal molecules 103 may be parallel to the alignment direction of the second guest-host liquid crystal molecules 203. For example, the alignment directions are both the Z direction. In this way, the target light L in a second polarization direction (which may include the X direction and/or the Y direction) emitted by the front light source 30 can sequentially pass through the second guest-host liquid crystal cell 20 and the first guest-host liquid crystal cell 10, and be reflected by the reflective electrode 102, and then sequentially pass through the first guest-host liquid crystal cell 10 and the second guest-host liquid crystal cell 20, thereby realizing reflective display. To be specific, neither the first guest-host liquid crystal molecules 103 nor the second guest-host liquid crystal molecules 203 are capable of blocking the target light L.

The display principle of the display panels shown in FIG. 8 and FIG. 9 is described by taking the normally white mode as an example. If the display panel operates in the normally white mode, the alignment direction of the first guest-host liquid crystal molecules 103 being perpendicular to the alignment direction of the second guest-host liquid crystal molecules 203 may be interpreted as being perpendicular in a powered state.

First, in conjunction with the display panel shown in FIG. 8, in an initial state (that is, an unpowered state), the first guest-host liquid crystal molecules 103 and the second guest-host liquid crystal molecules 203 may be arranged vertically. To be specific, the alignment direction of the first guest-host liquid crystal molecules 103 may be parallel to the alignment direction of the second guest-host liquid crystal molecules 203. For example, the alignment directions are both the Z direction. In this way, the target light L in the first polarization direction (which may include the X direction and/or the Y direction) emitted by the front light source 30 can pass through the first guest-host liquid crystal cell 10, be reflected by the reflective electrode 102, and then sequentially pass through the first guest-host liquid crystal cell 10 and the second guest-host liquid crystal cell 20, thereby realizing reflective display. To be specific, neither the first guest-host liquid crystal molecules 103 nor the second guest-host liquid crystal molecules 203 are capable of blocking the target light L.

Secondly, in conjunction with the display panel shown in FIG. 9, when a voltage is applied, that is, in a powered state, the alignment direction of the first guest-host liquid crystal molecules 103 may be perpendicular to the alignment direction of the second guest-host liquid crystal molecules 203. In this way, when the target light L is incident into the first guest-host liquid crystal cell 10, light whose polarization direction is the same as the alignment direction of the first guest-host liquid crystal molecules 103 cannot pass through the first guest-host liquid crystal cell 10 and cannot be reflected into the second guest-host liquid crystal cell 10. Only light whose polarization direction is different from the alignment direction of the first guest-host liquid crystal molecules 103 can pass through the first guest-host liquid crystal cell 10 and be reflected by the reflective electrode 102 into the second guest-host liquid crystal cell 20. In addition, since the alignment direction of the second guest-host liquid crystal molecules 203 is perpendicular to the alignment direction of the first guest-host liquid crystal molecules 103, when light reaches the second guest-host liquid crystal cell 20, the light is absorbed by the second guest-host liquid crystal molecules 203, such that the display panel is in a dark state. To be specific, in the powered state, the target light L in the second polarization direction can pass through the first guest-host liquid crystal cell 10, be reflected by the reflective electrode 102, and then pass through the first guest-host liquid crystal cell 10 to the second guest-host liquid crystal cell 20, and is absorbed by the second guest-host liquid crystal molecules 203.

Assuming that the alignment direction of the second guest-host liquid crystal molecules 203 is changed from the Z direction shown in FIG. 8 to the X direction shown in FIG. 9, and the alignment direction of the first guest-host liquid crystal molecules 103 is changed from the Z direction shown in FIG. 8 to the Y direction shown in FIG. 9, then the second polarization direction is the X direction. In other words, among the target light L, only the X-direction light can pass through the first guest-host liquid crystal cell 10 to the second guest-host liquid crystal cell 20, and be absorbed by the second guest-host liquid crystal molecules 203 whose alignment direction is the X direction. The same applies to ambient light.

The display principle of the display panels shown in FIG. 8 and FIG. 9 is described by taking the normally black mode as an example. If the display panel operates in the normally black mode, the alignment direction of the first guest-host liquid crystal molecules 103 being perpendicular to the alignment direction of the second guest-host liquid crystal molecules 203 may be interpreted as being perpendicular in an unpowered state.

First, in conjunction with the display panel shown in FIG. 9, in an initial state, the first guest-host liquid crystal molecules 103 may be perpendicular to the second guest-host liquid crystal molecules 203. In this way, when the target light L is incident into the first guest-host liquid crystal cell 10, light whose polarization direction is the same as the alignment direction of the first guest-host liquid crystal molecules 103 cannot pass through the first guest-host liquid crystal cell 10 and cannot be reflected by the reflective electrode 102 to the second guest-host liquid crystal cell 20. Only light whose polarization direction is different from the alignment direction of the first guest-host liquid crystal molecules 103 can pass through the first guest-host liquid crystal cell 10 to reach the second guest-host liquid crystal cell 20. Moreover, since the alignment direction of the first guest-host liquid crystal molecules 103 is perpendicular to the alignment direction of the second guest-host liquid crystal molecules 203, when light reaches the second guest-host liquid crystal cell 20, the light is absorbed by the second guest-host liquid crystal molecules 203, such that the display panel is in a dark state. To be specific, in the initial state, the target light L in the first polarization direction can pass through the first guest-host liquid crystal cell 10, be reflected by the reflective electrode 102, and then pass through the first guest-host liquid crystal cell 10 to the second guest-host liquid crystal cell 20, and is absorbed by the second guest-host liquid crystal molecules 203.

In some embodiments, assuming that the alignment direction of the second guest-host liquid crystal molecules 203 is the X direction shown in FIG. 9, and the alignment direction of the first guest-host liquid crystal molecules 103 is the Y direction shown in FIG. 9, then the first polarization direction is the X direction. In other words, among the target light L, only light whose polarization direction is the X direction can pass through the first guest-host liquid crystal cell 10 to the second guest-host liquid crystal cell 20, and be absorbed by the second guest-host liquid crystal molecules 203 whose alignment direction is the X direction. The same applies to ambient light.

Second, in conjunction with the display panel shown in FIG. 8, in a powered state, the first guest-host liquid crystal molecules 103 and the second guest-host liquid crystal molecules 203 may be arranged vertically. To be specific, the alignment direction of the first guest-host liquid crystal molecules 103 may be parallel to the alignment direction of the second guest-host liquid crystal molecules 203. For example, the alignment directions are both the Z direction. In this way, the target light L in the second polarization direction (which may include the X direction and/or the Y direction) emitted by the front light source 30 can pass through the first guest-host liquid crystal cell 10, be reflected by the reflective electrode 102, and then sequentially pass through the first guest-host liquid crystal cell 10 and the second guest-host liquid crystal cell 20, thereby realizing reflective display. To be specific, neither the first guest-host liquid crystal molecules 103 nor the second guest-host liquid crystal molecules 203 are capable of blocking the target light L.

In some embodiments, in conjunction with the display panel shown in any one of FIGS. 5 to 9, the front light source 30 according to the embodiment of the present disclosure may include a plurality of mini light-emitting diodes (mini-LEDs) 301 uniformly arranged. In this way, under the premise of simplifying the structure of the display panel, it is possible to ensure that the front light source 30 emits light uniformly, which further ensures a better display effect of the display panel.

In some embodiments, in conjunction with the display panel shown in any one of FIGS. 5 to 9, for cancelation of signal interference between the mini-LEDs 301 and other hierarchical structures (e.g., drive electrodes), the front light source 30 may also include an insulating layer 302. The insulating layer 302 may be an adhesive for packaging the mini-LEDs 301.

In some embodiments, in conjunction with FIG. 7, when the front light source 30 is disposed on an outer side of the two laminated guest-host liquid crystal cells, the display panel may further include a substrate 303. The mini-LEDs 301 and the insulating layer 302 may be laminated in sequence on a side of the substrate 303 proximal to the fourth substrate 205. To be specific, the mini-LEDs 301 and the insulating layer 302 may be disposed on the substrate 303 to form the front light source 30. In other words, the substrate 303 may be a part of the front light source 30,

The light-emitting structure (i.e., mini-LEDs) part of the front light source 30 is not limited in the embodiment of the present disclosure. To be specific, the light-emitting structure in the front light source 30 may also be other light-emitting devices except mini-LEDs. For example, the light-emitting structure in the front light source 30 may be an organic light-emitting diode.

In some embodiments, since light needs to pass through both the first guest-host liquid crystal cell 10 and the second guest-host liquid crystal cell 20, the smaller the gap between the two laminated guest-host liquid crystal cells (i.e., cell gap), the better the display effect of the display panel (equivalent to a transmissive structure). Therefore, in the embodiment of the present disclosure, the pitch between the first drive electrode 104 and the second drive electrode 202 may be set to be less than a pitch threshold.

In addition, after testing, under the premise that the pitch between the two laminated guest-host liquid crystal cells is small, only a small voltage needs to be applied to make the display panel display normally. In this way, the power consumption of the display panel is also reduced to a certain extent.

In some embodiments, for a better reflection effect, the reflective electrode 102 may be arranged in a convex or concave structure, so as to achieve a better display viewing angle. To be specific, a side of the reflective electrode 102 far distal from the first substrate 101 according to the embodiment of the present disclosure may be uneven.

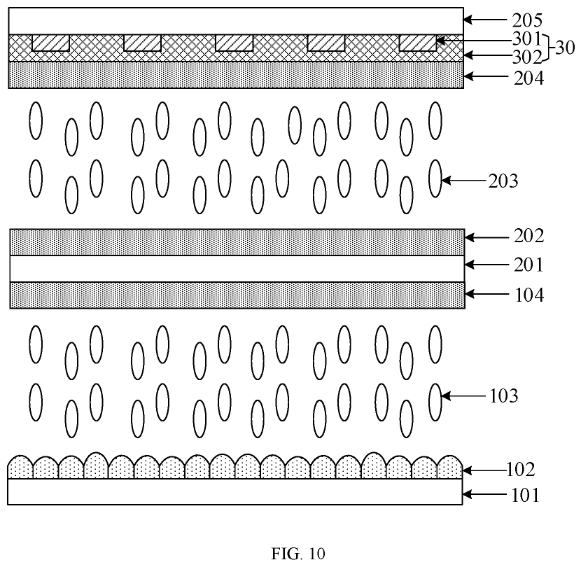

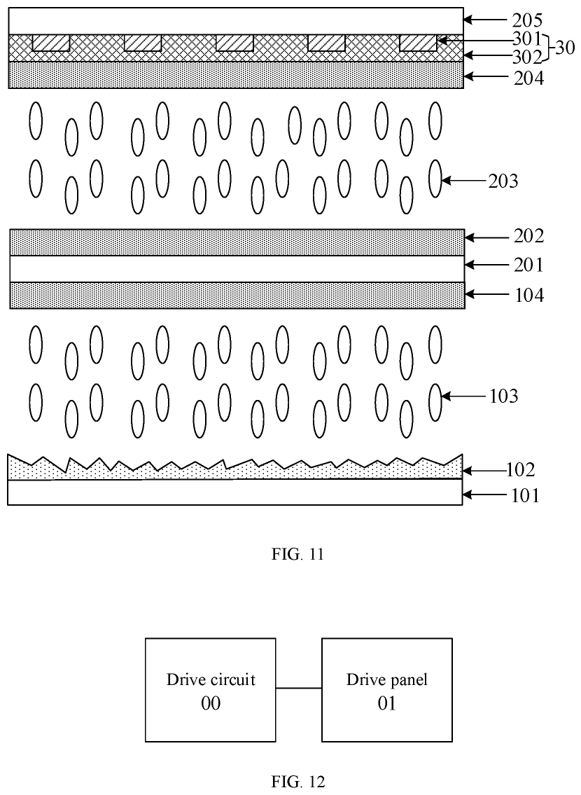

In some embodiments, as shown in another display panel shown in FIG. 10, the side of the reflective electrode 102 distal from the first substrate 101 may include a plurality of arc-shaped protrusions. Alternatively, as shown in another display panel shown in FIG. 11, the side of the reflective electrode 102 distal from the first substrate 101 may include a plurality of triangular protrusions.

In some embodiments, at least one of the first substrate 101, the second substrate 105, the third substrate 201, and the fourth substrate 205 included in the display panel according to the embodiment of the present disclosure may be a flexible substrate, that is, made of a flexible material, such as a polyimide (PI) material. For example, in the display panel, the shared second substrate 105 and the third substrate 201 may be PI flexible substrates.

By setting at least one substrate as a flexible substrate, not only can the overall thickness of the display panel be further reduced, making the display panel lighter and thinner, but also the display panel may be applied to folding products, which has a wide range of application scenarios.

In some embodiments, for normal incidence and reflection of light, the first drive electrode 104, the second drive electrode 202, and the third drive electrode 204 according to the embodiment of the present disclosure may all be transparent thin-film electrodes.

In some embodiments, the first drive electrode 104, the second drive electrode 202, and the third drive electrode 204 may all be ITO electrodes made of an indium tin oxide (ITO) material.

In some embodiments, the reflective electrode 102 according to the embodiment of the present disclosure may be made of a metal material, that is, a metal reflective electrode. Each of the first substrate 101, the second substrate 105, the third substrate 201, and the fourth substrate 205 may be a transparent glass substrate.

In some embodiments, for the color display of the display panel, the display panel according to the embodiment of the present disclosure may further include a color filter (CF). In some other embodiments, the CF may be disposed on a side of the fourth substrate 205 distal from the fourth drive electrode 204.

In summary, the embodiments of the present disclosure provide a display panel including a first guest-host liquid crystal cell having first guest-host liquid crystal molecules and a second guest-host liquid crystal cell having second guest-host liquid crystal molecules. Since an alignment direction of the first guest-host liquid crystal molecules is perpendicular to the alignment direction of the second guest-host liquid crystal molecules, light may be effectively reflected or absorbed by the first guest-host liquid crystal cell and the second guest-host liquid crystal cell. To be specific, the display panel according to the embodiment of the present disclosure can not only display normally, but also has a higher light reflectivity and a better display effect.

FIG. 12 is a schematic structural diagram of a display device according to an embodiment of the present disclosure. As shown in FIG. 12, the display device may include a drive circuit 00 and a display panel 01 as shown in any one of FIGS. 1 to 11. The drive circuit 00 may be connected to the display panel 01 and intended to drive the display panel 01 to operate.

In some embodiments, the display device may be any product or component with a display function, such as an LCD device, a mobile phone, a tablet computer, a television, a monitor, a notebook computer, or a navigator.

It should be understood that the “and/or” mentioned herein indicates be three relationships. For example, A and/or B refers to three situations: A alone exists, A and B exist at the same time, B alone exists. The symbol “/” generally indicates that the associated objects before and after are in an “or” relationship.

Described above are merely exemplary embodiments of the present disclosure, and are not intended to limit the present disclosure. Within the spirit and principles of the disclosure, any modifications, equivalent substitutions, improvements, and the like are within the protection scope of the present disclosure.

1. A display panel, comprising: a first guest-host liquid crystal cell and a second guest-host liquid crystal cell that are laminated in sequence; wherein
the first guest-host liquid crystal cell comprises a first substrate, a reflective electrode, first guest-host liquid crystal molecules, a first drive electrode, and a second substrate that are laminated in sequence; and
the second guest-host liquid crystal cell comprises a third substrate, a second drive electrode, second guest-host liquid crystal molecules, a third drive electrode, and a fourth substrate that are laminated in sequence;
wherein an alignment direction of the first guest-host liquid crystal molecules is perpendicular to an alignment direction of the second guest-host liquid crystal molecules, and a pitch between the first drive electrode and the second drive electrode is less than a pitch threshold.

2. (canceled)

3. The display panel of claim 1, wherein a side of the reflective electrode distal from the first substrate is uneven.

4. The display panel according to claim 1, further comprising: a front light source disposed on a side of the first drive electrode distal from the first guest-host liquid crystal molecules, the front light source being configured to emit target light.

5. The display panel of claim 4, wherein the front light source is disposed between the third drive electrode and the fourth substrate.

6. The display panel according to claim 4, wherein the front light source is disposed on a side of the fourth substrate distal from the third drive electrode.

7. The display panel according to claim 6, wherein
in a powered state, the alignment direction of the first guest-host liquid crystal molecules is perpendicular to the alignment direction of the second guest-host liquid crystal molecules;
in an unpowered state, the target light in a first polarization direction sequentially passes through the second guest-host liquid crystal cell and the first guest-host liquid crystal cell, and is reflected by the reflective electrode, and then sequentially passes through the first guest-host liquid crystal cell and the second guest-host liquid crystal cell; and
in the powered state, the target light in a second polarization direction passes through the second guest-host liquid crystal cell to the first guest-host liquid crystal cell, and is absorbed by the first guest-host liquid crystal molecules.

8. The display panel according to claim 6, wherein
in an unpowered state, the alignment direction of the first guest-host liquid crystal molecules is perpendicular to the alignment direction of the second guest-host liquid crystal molecules;
in the unpowered state, the target light in a first polarization direction passes through the second guest-host liquid crystal cell to the first guest-host liquid crystal cell, and is absorbed by the first guest-host liquid crystal molecules; and
in a powered state, the target light in a second polarization direction sequentially passes through the second guest-host liquid crystal cell and the first guest-host liquid crystal cell, and is reflected by the reflective electrode, and then sequentially passes through the first guest-host liquid crystal cell and the second guest-host liquid crystal cell.

9. The display panel according to claim 4, wherein the front light source is disposed on a side of the third substrate distal from the second drive electrode.

10. The display panel according to claim 9, wherein
in a powered state, the alignment direction of the first guest-host liquid crystal molecules is perpendicular to the alignment direction of the second guest-host liquid crystal molecules;
in an unpowered state, the target light in a first polarization direction passes through the first guest-host liquid crystal cell, is reflected by the reflective electrode, and then sequentially passes through the first guest-host liquid crystal cell and the second guest-host liquid crystal cell; and
in the powered state, the target light in a second polarization direction passes through the first guest-host liquid crystal cell, is reflected by the reflective electrode, and then passes through the first guest-host liquid crystal cell to the second guest-host liquid crystal cell and is absorbed by the second guest-host liquid crystal molecules.

11. The display panel according to claim 9, wherein
in an unpowered state, the alignment direction of the first guest-host liquid crystal molecules is perpendicular to the alignment direction of the second guest-host liquid crystal molecules;
in the unpowered state, the target light in a first polarization direction passes through the first guest-host liquid crystal cell, is reflected by the reflective electrode, and then passes through the first guest-host liquid crystal cell to the second guest-host liquid crystal cell and is absorbed by the second guest-host liquid crystal molecules; and
in a powered state, the target light in a second polarization direction passes through the first guest-host liquid crystal cell, is reflected by the reflective electrode, and then sequentially passes through the first guest-host liquid crystal cell and the second guest-host liquid crystal cell.

12. The display panel according to claim 4, wherein the front light source comprises a plurality of micro light-emitting diodes evenly arranged.

13. The display panel according to claim 12, wherein the front light source further comprises an insulating layer configured to package the plurality of micro light-emitting diodes.

14. The display panel according to claim 1, wherein at least one of the first substrate, the second substrate, the third substrate, and the fourth substrate is a flexible substrate.

15. The display panel according to claim 1, wherein the second substrate is shared with the third substrate.

16. The display panel according to claim 1, wherein the first drive electrode, the second drive electrode, the third drive electrode, and the fourth drive electrode are all transparent thin-film electrodes.

17. The display panel according to claim 1, wherein the reflective electrode satisfies one of the following conditions: a metal electrode and a reflective layer are laminated in sequence in a direction distal from the first substrate, and the reflective electrode is made of a conductive material with a reflectivity greater than a reflectivity threshold.

18. The display panel according to claim 1, further comprising: a color filter disposed on a side of the fourth substrate distal from the fourth drive electrode.

19. The display panel according to claim 7, wherein
a side of the reflective electrode distal from the first substrate is uneven;
the front light source comprises a plurality of uniformly arranged micro light-emitting diodes and an insulating layer configured to package the plurality of micro light-emitting diodes;
at least one of the first substrate, the second substrate, the third substrate, and the fourth substrate is a flexible substrate;
the second substrate is shared with the third substrate;
the first drive electrode, the second drive electrode, the third drive electrode, and the fourth drive electrode are all transparent thin-film electrodes;
the reflective electrode satisfies one of the following conditions: a metal electrode and a reflective layer that are laminated in sequence in a direction distal from the first substrate, and the reflective electrode being made of a conductive material with a reflectivity greater than a reflectivity threshold; and
the display panel further comprises a color filter disposed on a side of the fourth substrate distal from the fourth drive electrode.

20. A display device, comprising: a drive circuit and a display panel;
wherein the drive circuit is connected to the display panel, and the drive circuit is configured to drive the display panel to operate; and
the display panel comprises a first guest-host liquid crystal cell and a second guest-host liquid crystal cell that are laminated in sequence;
the first guest-host liquid crystal cell comprises a first substrate, a reflective electrode, first guest-host liquid crystal molecules, a first drive electrode, and a second substrate that are laminated in sequence; and
the second guest-host liquid crystal cell comprises a third substrate, a second drive electrode, second guest-host liquid crystal molecules, a third drive electrode, and a fourth substrate that are laminated in sequence;
wherein an alignment direction of the first guest-host liquid crystal molecules is perpendicular to an alignment direction of the second guest-host liquid crystal molecules, and a pitch between the first drive electrode and the second drive electrode is less than a pitch threshold.

21. A display panel, comprising: a first guest-host liquid crystal cell and a second guest-host liquid crystal cell that are laminated in sequence, and a front light source; wherein
the first guest-host liquid crystal cell comprises a first substrate, a reflective electrode, first guest-host liquid crystal molecules, a first drive electrode, and a second substrate that are laminated in sequence; and
the second guest-host liquid crystal cell comprises a third substrate, a second drive electrode, second guest-host liquid crystal molecules, a third drive electrode, and a fourth substrate that are laminated in sequence;
the front light source is disposed on a side of the third substrate distal from the second drive electrode and is configured to emit target light;
wherein in a powered state, an alignment direction of the first guest-host liquid crystal molecules is perpendicular to an alignment direction of the second guest-host liquid crystal molecules;
in an unpowered state, the target light in a first polarization direction passes through the first guest-host liquid crystal cell, is reflected by the reflective electrode, and then sequentially passes through the first guest-host liquid crystal cell and the second guest-host liquid crystal cell; and
in the powered state, the target light in a second polarization direction passes through the first guest-host liquid crystal cell, is reflected by the reflective electrode, and then passes through the first guest-host liquid crystal cell to the second guest-host liquid crystal cell and is absorbed by the second guest-host liquid crystal molecules.
